(19) United States
(12) Patent Application Publication
(10) Pub. No.: US 2012/0261485 A1
(43) Pub. Date: Oct. 18, 2012

(54) SPRAY NOZZLE

(76) Inventor: Kaj Mickos, Nacka (SE)

(21) Appl. No.: 13/448,455

(22) Filed: Apr. 17, 2012

Related U.S. Application Data
(60) Provisional application No. 61/476,733, filed on Apr. 18, 2011.

(51) Int. Cl. A62C 5/02

(52) U.S. Cl. 239/8

(57) ABSTRACT

A spray nozzle is attached onto a faucet. The spray nozzle has a discharge opening defined therein. Water is permitted to flow into the spray nozzle. The water is rotated in a vortex inside the spray nozzle. The rotating water is discharged through the discharge opening. The rotating water is flash evaporated into a mist.

### PRIOR APPLICATION

This is a US utility patent application that claims priority from U.S. provisional patent application Ser. No. 61/476,733, filed 18 Apr. 2011.

### TECHNICAL FIELD

The present invention relates to a low water-consumption spray nozzle that has a housing and a washer that is received in the housing. The housing is equipped with a detachable device to connect the housing to a faucet or the like. The housing has a front portion that is provided with an orifice for discharge of water. The nozzle flash evaporates the water into a fine mist.

### BACKGROUND AND SUMMARY OF THE INVENTION

A primary object of the present invention is to present a spray nozzle that will perform a water saving function when water is discharged from the faucet.

A further object of the present invention is that the spray nozzle according to the present invention is extremely simple as regards the structural design.

A spray nozzle of the present invention is attached onto a faucet. The spray nozzle has a discharge opening defined therein. Water is permitted to flow into the spray nozzle. The water is rotated in a vortex inside the spray nozzle. The rotating water is discharged through the discharge opening. The rotating water is flash evaporated into a mist.

### BRIEF DESCRIPTION OF THE DRAWINGS

A preferred embodiment of the spray nozzle according to the present invention will be described below, reference being made to the accompanying drawings where:

FIG. 1 shows a perspective view from above of the spray nozzle according to the present invention;

FIG. 2 shows a perspective view from beneath of the spray nozzle according to the present invention;

FIG. 3 shows a side view of the spray nozzle according to the present invention;

FIG. 4 shows the section A-A in FIG. 3;

FIG. 5 shows a top view of the spray nozzle according to the present invention;

FIG. 6 shows the section B-B in FIG. 5;

FIG. 7 shows a perspective view from beneath of a washer that forms a part of the spray nozzle according to the present invention;

FIG. 8 shows a top view from beneath of the washer that forms a part of the spray nozzle according to the present invention;

FIG. 9 shows a section through the orifice in an enlarged scale;

FIG. 10 is a side view of a cleaning station including the spray nozzle of the present invention.

### DETAILED DESCRIPTION

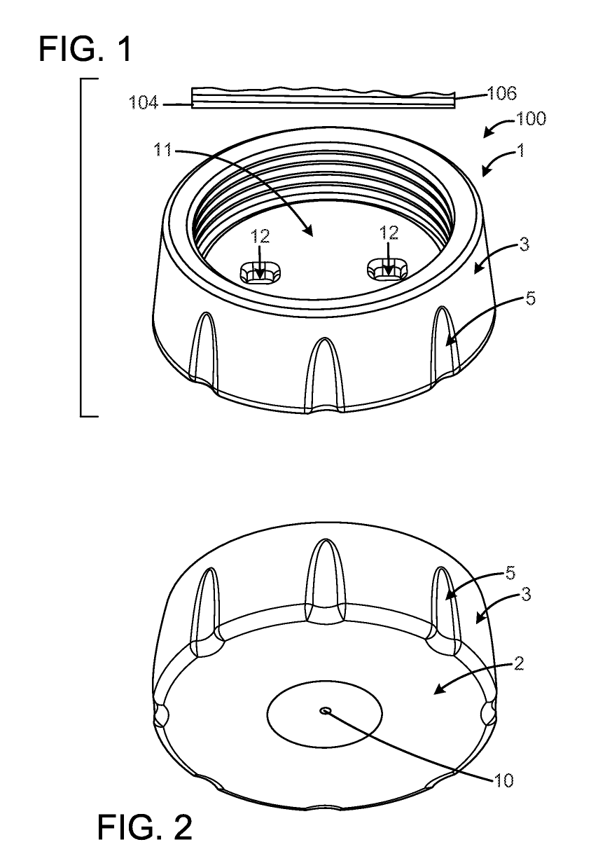

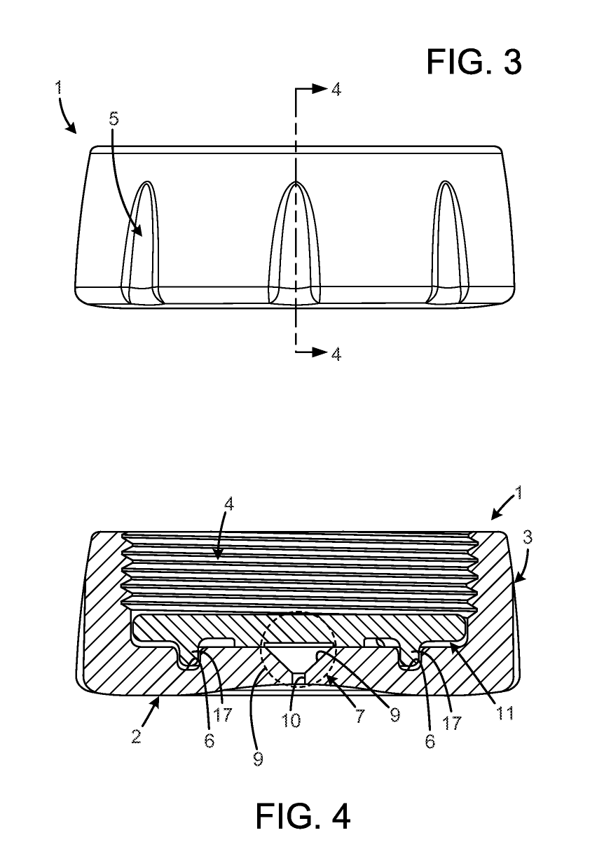

The misting nozzle or spray nozzle 100 of the present invention is used to create a mist through a flash evaporation process with a minimum consumption of water. The nozzle 100 has a housing 1 that includes a front portion 2 (best seen in FIG. 2) and a circular or peripheral outer wall portion 3 that preferably is integral with the front portion 2. The wall portion 3 is on its inner side 102 provided with an internal thread 4 in order to detachably mount the spray nozzle 100 on a faucet 104 or the like. The internal thread 4 is then used to engage an external thread 106 of the faucet 104. The housing 1 is provided with external grooves 5, see FIGS. 1 and, that extend in the axial direction of the housing 1. The groove 5 enables a proper grip by a hand or tool when mounting or dismounting the spray nozzle on the faucet 104 or the like.

As best seen in FIG. 4, the housing 1 is provided with an annular groove 6 in an inner side of the front portion 2. The groove 6 is intended to perform a sealing function as described in more detail below. The housing 1 has a central orifice 7 defined therein that has a conical inlet portion 9 and a tubular outlet portion 10. The tubular outlet portion 10 of the orifice 7 emerges in an exteriorly recessed central area of the housing 1.

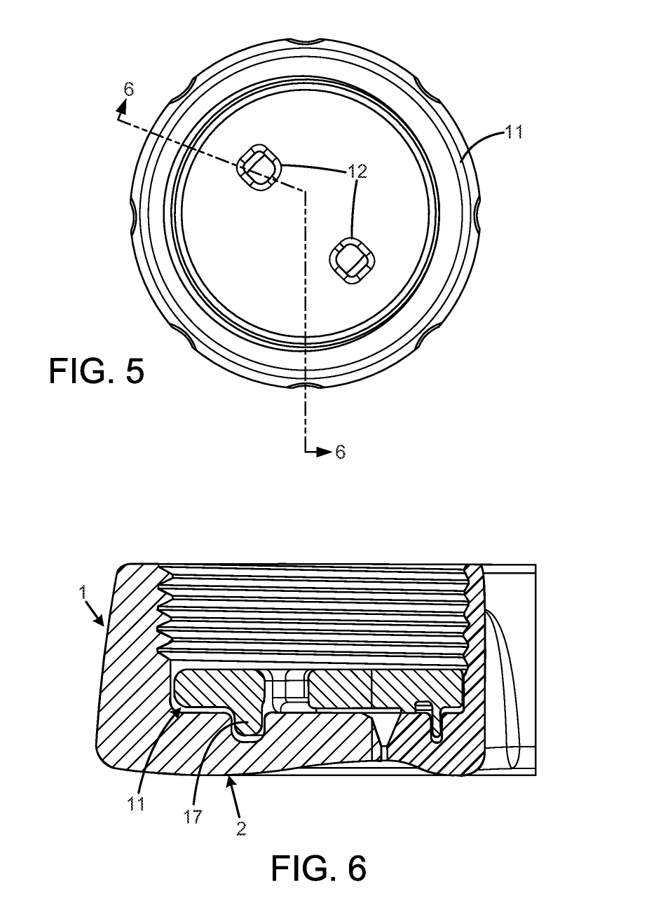

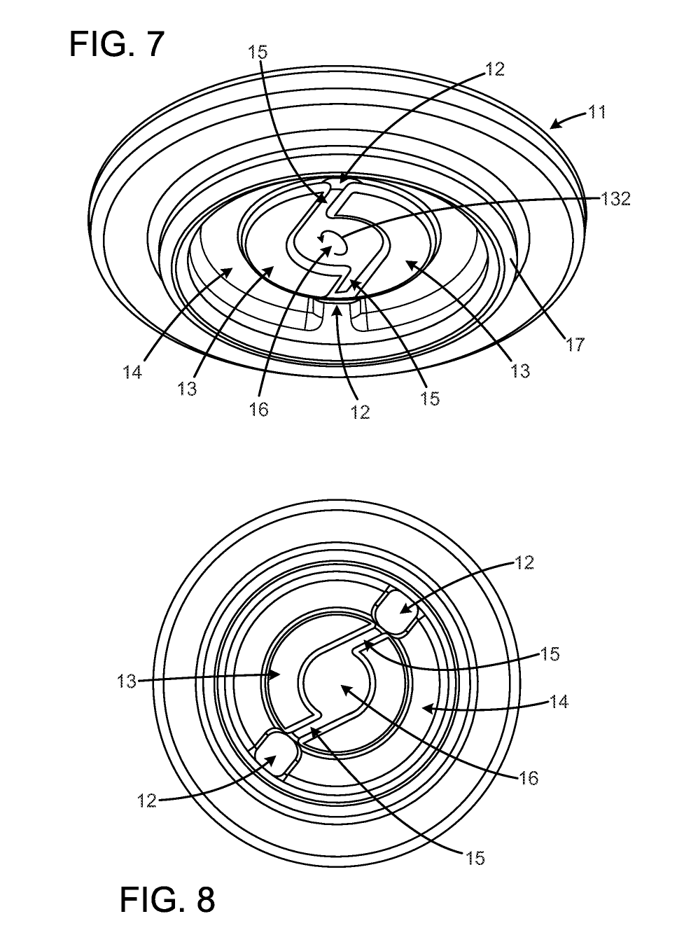

The spray nozzle 100 also has a removable washer 11 disposed therein that is shown in FIGS. 4-5 and 7. The function of the washer is important, as described below, because it creates a vortex of the flowing water in a flash evaporation process. The washer 11 has openings 12 defined therein for receiving water flowing from the faucet 104. The openings 12 are located diametrically in relation to the center of the washer 11. Generally, the washer 11 is flat on the upper side, i.e. the side that is visible in FIG. 5 and that faces the faucet 104. On the lower side of the washer 11, i.e. the side faces the orifice 7, the washer 11 is provided with a centrally located, generally circular portion 13 that is somewhat elevated relative to the portion 14 that surrounds the generally circular portion 13. In the circular portion 13, channels 15 are defined therein to create a vortex flow of the water, as mentioned above, since the water flow from the two opposite openings 12 that flows in via the channels 15 is circulated in a vortex 132 in the portion 16. The important feature is that the water is rotated which may be done in a way different from using two oppositely directed channels 15 that creates the vortex 132. More particularly, the channels 15 extend from the openings 12 to a central sub-portion 16 that is recessed in the centrally located, generally circular portion 13. The channels 15 are also recessed in the centrally located, generally circular portion 13. This is best seen in FIG. 7. The central recessed sub-portion 16 has a generally circular contour. Preferably, the channels 15 and the central sub-portion 16 have the same depth in the generally circular portion 13.

The washer 11 is provided with an annular projection 17 that faces towards the front portion 2 of the housing 1. The openings 12 are located inside the projection 17. The openings 12 are located immediately adjacent the projection 17.

When the washer 11 is properly mounted in the housing 1, as best seen in FIG. 4, the annular projection 17 is received in the annular groove 6. The dimensions of the annular groove 6 and the annular projection 17 are mutually adapted to each other in order to have a proper sealing action when the annular projection 17 is received in the annular groove 6.

When the washer 11 is properly mounted in the housing 1, the central sub-portion 16 is located opposite the conical inlet portion 9 of the orifice 7. The channels 15 and the inner side of the front portion 2 define a water passage that transports water from the openings 12 to the central sub-portion 16 wherein the vortex is created. More particularly, the central sub-portion 16 together with the conical inlet portion 9 define a vortex chamber for the water emanating from the passages defined by the channels 15 and the inner side of the front portion 2.

In operation, the spray nozzle 100 is first properly mounted on the faucet 104 or the like. Water 106 emerging from the faucet flows through the openings 12 so that the openings 12 restrict the flow of the water, i.e. the openings 12 reduce the outgoing water pressure from the faucet when the water enters the water passages that are defined by the channels 15 and the inner side of the front portion 2. A typical pressure of the water that is discharged from the faucet is about 2-3 bar. In the vortex chamber that is defined by the central sub-portion 16 and the inlet portion 9 there should be a water pressure of at least 1 bar but less than the original pressure such as 2-3 bar in order to make the spray nozzle function in a proper way. It is also possible that the pressure in the vortex chamber is about the same as the original pressure in the faucet i.e. about 2-3 bars. When the water 106 flows through the openings 12 and enters the water passages that are defined by the channels 15 and the inner side of the front portion 2 it is important that the sealing function between the groove 6 and the projections 17 is working properly in order to direct all water into the conical inlet portion 9. FIG. 8 shows that the channels 15 and thus the water passage emerge at the periphery of sub-portion 16. Since the conical inlet portion 9 is opposite the sub-portion 16 the water also flows along the periphery of the conical inlet portion 9. Thus, the water 106 flows in the vortex chamber that is defined by the conical inlet portion 9 and the central sub-portion 16. The water 106 then descends towards the tubular outlet portion 10 and the water is discharged through the tubular outlet portion 10. When the water 106 leaves the tubular outlet portion 10 the water 106 assumes a shape of a cone. Due to the relatively small area of the openings/restriction means 12 the water consumption is kept at a low level when the nozzle 100 is mounted on a faucet.

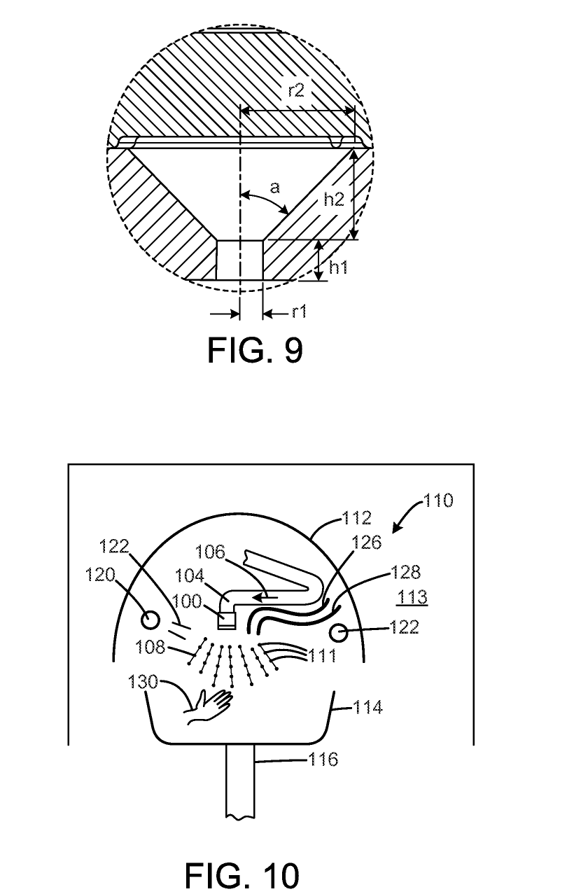

In FIG. 9 the central sub-portion 16 of the washer 11, the conical inlet portion 9 of the front portion 2 and the tubular outlet portion 10 of the front portion 2 are disclosed in an enlarged scale. In FIG. 9 a relationship is defined between parameters of the orifice in the front portion.

In the embodiment disclosed above and in the accompanying drawings, the washer 11 is provided with a projection 17 and the inner side of the front portion 2 is provided with an annular groove 6 that cooperate to establish a sealing function. Within the scope of the present invention it is possible to have an alternative sealing arrangement, e.g. a loose sealing in the shape of an O-ring that is located between the washer and the inner side of the front portion 2.

In the embodiment disclosed above and in the accompanying drawings, the housing 1 is provided with an internal thread 4 to mount the housing 1 on a faucet or the like. It is possible to use alternative means, e.g. a bayonet coupling.

One important application of the spray nozzle 100 is in a cleaning station 110 that includes the faucet 104, a round shield 112 mounted on a wall 113 disposed above a sink container 114 connected to a drainage 116. The cleaning station 110 is for improved hygiene by atomizing the water 106 flowing through the spray nozzle 100. The user may insert the user's hands 130 under the faucet 104 inside the shield 112 to wash the hands. The water is atomized in the spray nozzle 100 so that a fine cone-shaped mist, fog or spray 108 (best seen in FIG. 10) is ejected therefrom that includes almost an infinite number of water droplets. In other words, the spray nozzle 100 converts the water 106 into the fine mist 108 by using high pressure. The water droplets 111 released through the nozzle 100 are so small that they are measured in microns so that the surface area of the water is very large and it is possible to maximize the use of the surface area of each droplet. This is because the holes in the nozzle are exceptionally small. When the water passes through the nozzle 100, it is effectively vaporized as a result of flash evaporation. As a result of flash evaporation, the mist 108 is formed. This mist 108 is particularly suitable for hand washing while reducing the water consumption without reduced efficiency or comfort. The water consumption could be as low as 50 milliliter for a normal hand-wash. One surprising effect is that it is possible to effectively wash the hands despite the extremely low consumption of water. The water may be disinfected during the washing by used a bacteria killing filter 118 such as a silver-oxide based filter or any other suitable filter. In other words, the water is subjected to a silver-based substance. It is also possible to use an ultraviolet light device 120 so that ultraviolet light 122 is directed towards the mist 108 while making the mist visible. The device 120 may also be placed on the faucet 104. It is possible to use a sensor 124 that automatically activates the faucet 104 when hands are inserted under the shield 112. It is also possible to automatically eject a suitable amount of soap from a soap source 126 before the mist 108 is turned on. The hand may then be automatically showered with alcohol from an alcohol source 128.

Because the amount of water used is so small, the drainage 116 may be very weak and made of a bendable and flexible material. It is also possible to make the cleaning station 110 very small and use small and/or narrow spaces that are normally too small for a cleaning station. It is also possible to simply screw on the spray nozzle 100 to a conventional faucet in an already existing sink. It is also possible to use a plurality of nozzles 100 into order to spray and disinfect the entire body of the user. A suitable perfume with a pleasant smell may be added to the water 106 since the consumption is so small.

It is also possible to heat the water with an electric devise directly at the faucet and to use a multiple of spray nozzles together to form a shower.

It is also possible to connect the spray nozzle to a container containing water and air where the air is compressed by the means of a pump or the like to force the water to exit from the container through a tube passing filters and silver/copper ions, or the like, to purify the water and ending with a spray nozzle connected to the tube creating a mist for economical use of the purified water.

While the present invention has been described in accordance with preferred compositions and embodiments, it is to be understood that certain substitutions and alterations may be made thereto without departing from the spirit and scope of the following claims.

1. A method of discharging water through a faucet, comprising:
attaching a spray nozzle onto a faucet, the spray nozzle having a discharge opening defined therein,
flowing water into the spray nozzle,
rotating the water in a vortex inside the spray nozzle,
discharging the rotating water through the discharge opening and,
flash evaporating the rotating water into a mist.

2. The method according to claim 1, the method further comprises flowing the water through a disinfecting filter prior to discharging the water through the discharge opening.

3. The method according to claim 1, the method further comprises subjecting the mist to an ultraviolet light.

4. The method according to claim 3, the method further comprises the ultraviolet light making the mist visible and killing bacteria and virus.

5. The method according to claim 2, the method further comprises subjecting the water to a filter with silver/copper ions to sanitize the water.

6. The method according to claim 1, the method further comprises using a sensor to automatically activate the faucet.

7. The method according to claim 1, the method further comprises adding a perfume to the water prior to the water flowing out from the faucet.

8. The method according to claim 1 further comprises heating the water with an electric devise directly at the faucet.

9. The method according to claim 1, further comprises using a multiple of spray nozzles together to form a shower.

10. The method according to claim 1 comprising connecting the spray nozzle to a container containing a liquid and air and compressing the air by a pumping device to force the water to exit from the container through a tube passing filters and silver/copper ions to purify the water and the spray nozzle creating a mist.
